(19) United States
(12) Patent Application Publication
(10) Pub. No.: US 2010/0224043 A1
(43) Pub. Date: Sep. 9, 2010

(54) Sawmills and parts therefor

(76) Inventors: Carl James Peterson, Mamaku (NZ); Karl Jacob Peterson, Tauranga (NZ)

Correspondence Address: Carl James Peterson;Karl Jacob Peterson, #3 Arahiwi Road, Mamaku, 3020, omitted

(21) Appl. No.: 12/664,386

(22) PCT Filed: Jun. 12, 2008
(86) PCT No.: PCT/NZ08/00144

§ 371 Date: May 5, 2010

(30) Foreign Application Priority Data
Jun. 12, 2007 (NZ) 555792

(51) Int. Cl. B27B 7/02; B27B 33/08

(52) U.S. Cl. 83/471.3; 83/835; 83/486.1

(57) ABSTRACT

A sawmill uses a circular saw blade for use in horizontal or swing-blade sawing applications that has (1) has a central attachment (5) suitable for functionally attaching the blade to a driving mechanism with countersunk “flush” mounting attachment elements, a series of saw teeth (2) at the periphery of the blade, a series of apertures (3) between the teeth and the attachment portion, arranged to substantially reduce the weight and surface area of the blade by at least 5%, consequently reducing blade sag in horizontal position, friction and heat distortion in horizontal position, and/or gyroscopic stresses coming to bear on the blade and its mounting during the process of changing the blade from one disposition to another.

### FIELD OF INVENTION

The invention relates to the art of sawmills. Particularly preferred forms of the invention relate to sawmills using circular saw blades with apertures in the cutting face of the blade in conjunction with a horizontal, or “swinging blade” sawmill configuration; and/or the method of combining the little known art of blade apertures with the known art of horizontal, and/or “swinging blade” usage.

### BACKGROUND

It is known to use portable sawmills to mill a log laying on the ground or on a log support into boards or flitches. Such sawmills often have a frame which is set up around the log supporting a circular saw above the log, or alternatively have the means to place the log in or on the sawmill/log support frame. With a swing blade sawmill the saw is run along the log with its blade in a vertical orientation to make a vertical cut along the length of the log. The blade is then swung through 90 degrees so that it assumes a horizontal disposition and is run back along the log to make a horizontal cut which intersects with the vertical one. By repeating this process several times, with horizontal and vertical adjustments to the saw as need be, the log is progressively milled into a number of boards. Examples of portable saws of this type are described in patent specification WO 03037580 to Peterson. Alternatively, some mills of the swinging blade type can conceivably be arranged in such a way that the log passes through the blade to the same effect. Another known type of sawmill uses one or more blades in a fixed horizontal disposition along with a vertical blade to effect board removal with each pass down and back the log to similar effect as in the swing blade system.

In the context of horizontal, or swing blade sawmilling, it is often desirable to use a relatively large saw blade, for example one which has an 8 inch or larger cut capacity. In the past saw blades made to achieve horizontal cuts of that size have been formed of relatively thick steel to provide extra blade mounting strength, and thus avoid sagging of the blade when operating in a horizontal orientation, prevent distortion and heat build up from the weight of the overhead sawn board rubbing against the blade, accommodate the considerable gyroscopic forces brought into play against the blade and blade mounting during blade change-over from the horizontal position to the vertical or from the vertical to the horizontal, and provide for more strength at the point of mounting, which is limited to counter-sunk, or “flush” attachment devices.

However, a move to thicker steel with wider saw teeth can have an adverse affect on the accuracy, speed, cutting size capability and efficiency of the sawmill, and often goes hand in hand with increased blade stress, blade wear, and general wear and tear on other parts of the sawmill. This can lead to a shorter than desirable blade life, higher general capital and maintenance costs, and/or the necessity of a reduced cutting size capacity. It is an object of the preferred form of the invention to go at least some way towards addressing at least some these problems known to exist in the industry, or to at least provide the public with a useful choice.

### SUMMARY OF INVENTION

According to one aspect of the invention there is provided a sawmill that uses a circular saw blade which is itself used at least partly in a horizontal disposition, having a central attachment portion suitable for functionally attaching the blade to a driving mechanism with the bottom side of the horizontal blade mounted in a manner flush with the blade surface, a series of saw teeth at the periphery of the blade, a series of apertures between the teeth and the attachment portion arranged to substantially reduce the weight and/or surface area of the blade exposed outside of the central attachment portion; thus overcoming some degree of blade “sag” in the horizontal position, reducing friction and blade distortion from the weight of an overhead sawn board, greatly diminishing the gyroscopic forces resisting the blade change-over process, and/or reducing stress upon the very limiting type of blade mounting required.

Preferably at least some of the series of apertures extend around the periphery of the blade immediately adjacent the teeth.

Optionally the apertures are substantially circular.

Optionally the apertures are substantially oblong.

Preferably the apertures are arranged such that they serve to capture and hold sawdust during cutting a wooden object such that the held sawdust is expelled from the blade when the apertures which have caught that sawdust are outside the object on their way back into the object.

Preferably the apertures account for approximately 5% to 35% of the surface area of the blade exposed outside of the central attachment portion.

Preferably the apertures account for approximately 5% to 30% of the surface area of the blade exposed outside of the central attachment portion.

Preferably the apertures account for approximately 8% to 25% of the surface area of the blade exposed outside of the central attachment portion.

Preferably the apertures account for approximately 10% to 20% of the surface area of the blade exposed outside of the central attachment portion.

Preferably apertures nearer the periphery of the blade are larger than apertures nearer the attachment portion.

Preferably the apertures are arranged in concentric bands.

According to a further aspect of the invention there is provided the method of combining saw mills and saw mill blades used in horizontal or “swinging” dispositions with the lesser known art of placing apertures within the body of the cutting area of vertical cutting blades, in order to overcome existing known size and cutting capacity limitations within this area of the industry; particularly the limitations imposed by horizontal blade sag, friction heat and distortion from an overhead sawn board, the gyroscopic forces coming to bear on the blade mounting elements during blade changeover, and stresses imposed upon the limiting type of blade mounting required. These limitations are unique to saw mills utilizing horizontal blades, or swinging type sawmills that reciprocate between two generally perpendicular dispositions.

It will be appreciated that this combination of synergetic benefits is neither known nor expected within the industry; the known art of blade apertures in vertical blades being largely ignored in the industry due to the relatively insignificant benefits achieved, and the added costs of incorporating the apertures in the manufacturing process. Indeed, it is known and accepted in the industry that extra blade weight in vertically operated blades can supply a benefit in such operations, acting as an added inertial storage device such as a flywheel, and allowing the saw to apply added torque through difficult knots encountered during the sawing process. Whereas in vertical operation blade weight is generally an asset, in horizontal or swing blade operation, extra blade weight is very much a liability. As well, vertical sawing applications generally have stronger and more secure blade attachment means that can accommodate heavier blades without negative effect.

In the case of horizontal or swing blade sawmill use, the benefits of reducing blade weight can be enormous and well worth the added expense.

### GENERAL DESCRIPTION OF THE DRAWINGS

Some preferred embodiments of the invention will now be described by way of example and with reference to the accompanying drawings, of which:

FIG. 1 illustrates a circular saw blade suitable for use in the context of saw milling; and

FIG. 2 illustrates a saw blade swing mechanism, also suitable for use in the context of swing blade sawmilling.

### DETAILED DESCRIPTION

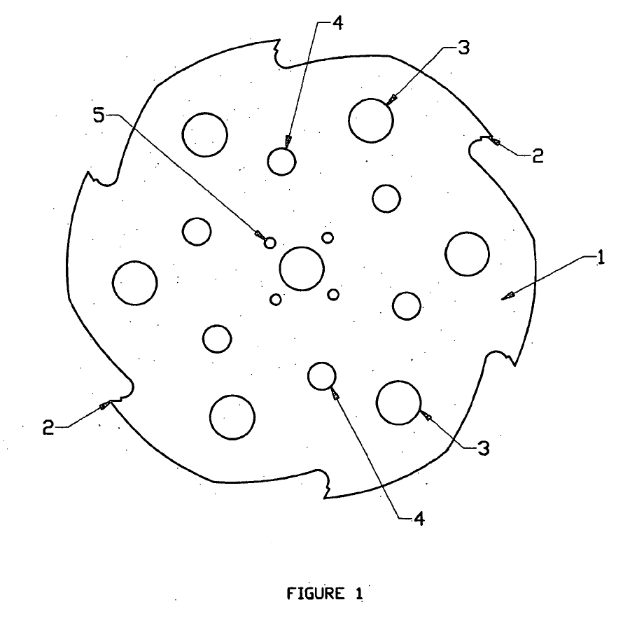

FIG. 1 shows a circular saw blade 1 suited for use in making greater than 10 inch cuts in the context of portable sawmilling. While the blade is of the stated size the invention should not be seen as limited to that. The blade is largely formed from steel, titanium or some other suitable metallic substance and may have diamond tipped teeth 2. To reduce the weight and/or surface area of the blade 1 it has a first ring of large apertures 3 around its periphery, just inside the teeth. A second ring of smaller apertures 4 is situated further inwards of the blade, nearer the blade's central boss attachment countersunk apertures 5. In some embodiments of the invention there may be a third ring or more of blade apertures to reduce blade weight and surface area, depending on the desired application for a blade. Preferably the rings or apertures are concentric but that is not essential.

The reduction in blade weight due to the apertures 3, 4 is significant because it enables one to have larger blades 1 without having to deal with the normal drawbacks associated with heavier blade rim weights, for example increased and varying centrifugal forces which can stretch or distort heavy blades. This is particularly significant during blade changeover, when gyroscopic forces magnify those centrifugal forces many times over. As such, there is a tremendous synergetic benefit in using blades with apertures in horizontal and swinging blade applications far greater than in known, though uncommon, vertical use of such blades. A lighter blade also means that one need not use such heavy duty sawmill components for swinging the blade 1 between horizontal and vertical orientations. A lighter blade can also reduce the propensity for blade sag when cutting in a horizontal orientation, which enhances cutting accuracy and can serve to reduce blade damage and premature wear. A lighter blade can also reduce blade mounting requirements, allowing a smaller than normal diameter blade boss; and consequently a smaller diameter saw blade for a given cutting capacity, thus further reducing the weight of the blade, and allowing even thinner blade steel to be used.

In addition to reducing the weight of the blade it has been found that the large and smaller apertures 3, 4 allow a good flow of air through the blade to prevent over-heating when in operation. The apertures 3, 4 also allow water, cooling fluid generally, or lubricant generally, to pass from one side of the blade to the other and thus further reduce the risk of overheating. The apertures 3, 4 facilitate a reduction in friction against the log being sawn as there is less blade face in contact with the log and/or sawn board, and less blade surface in contact with sawdust coming from a cut. The apertures 3, 4 also serve to capture sawdust and carry it away from the area of a cut. In this regard the saw dust is thrown clear soon after the apertures 3, 4 emerge from the cut, ie on route back into the cut. The apertures 3, 4 may also serve to even-out or balance tension in the blade 1 so that the blades need not be made in a slight dish shape, ie to account for blade distortion as it spins at high speed. In some embodiments of the invention the apertures 3, 4 serve to ‘polish’ a cut to give it a good finish.

All of these aspects combine for a further synergetic effect in that considerably thinner blade steel can be used, thus allowing thinner, faster, and more efficient cutting tips to be installed upon the blades; and/or blades of the same standard thickness can be employed in larger diameter, and thus with larger cutting capacity.

Preferably the apertures account for 5%-35%, more preferably 8%-30%, and most preferably 10%-25%, of the blade area outside the blade's central boss attachment apertures 5. The blade area outside the blade's central boss attachment apertures may or may not be taken to include the gullet spaces immediately adjacent to the blade's teeth. The lower percentage figures are generally best for large blades working at high horsepower (eg 1 m diameter and 50 HP) and the higher percentage values are best for small blades working at low horsepower (225 mm diameter and % HP). The 10%-25% range has been found particularly useful in the context of portable sawmills operating at 13-50 horsepower with 400 mm 800 mm diameter blades.

While the blade 1 has been described as particularly applicable to portable sawmills with horizontal and/or swinging blades, it will be appreciated by those skilled in the art that it can be used in a myriad of other applications. The blade can, for example, be used in non-portable, non-swinging horizontal, non-swinging vertical, or other angular, cutting arrangements, etc., although the greatest synergetic benefits are obtained in horizontal or “swinging blade” use, wherein the blades are mounted on the blade mounting in a manner in which the bottom surface of the blade in horizontal position has a flush surface which limits the strength of the mounting elements.

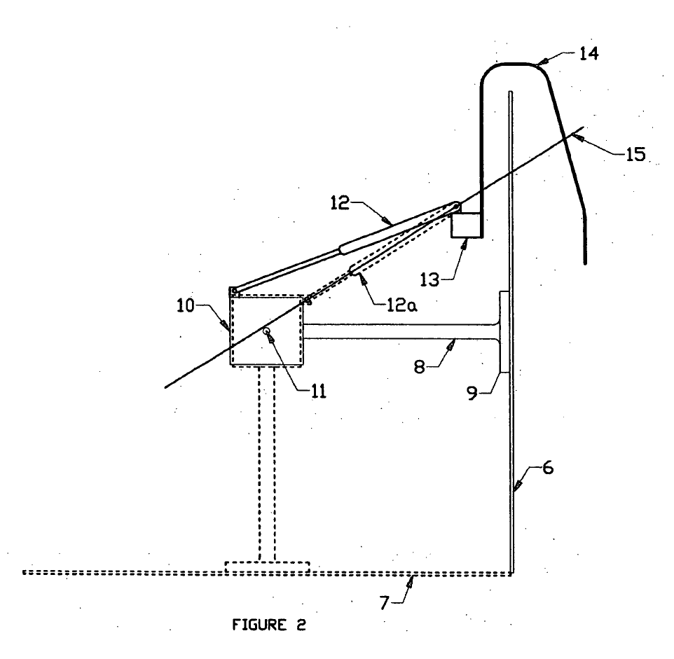

FIG. 2 illustrates the way the blade 1 is swung between vertical and horizontal orientations when in use as part of a portable sawmill. The blade's vertical orientation 6 is shown in hard lines and the blade's subsequent horizontal orientation 7 is shown in broken lines. As illustrated, the blade 1 is mounted on a shaft 8 via an arbor 9. The shaft 8 proceeds to a first mount or gear box 10 which enables the blade 1 to swing through 90 degrees (between the vertical and horizontal orientations) about a pivot point 11. An extendable gas strut 12 extends from the gear box 10 to an upper mount 13 connected to a blade guard 14. When the blade 1 is in the vertical orientation 6 the strut 12 is at maximum extension. The contracted disposition of the strut when the blade is in the horizontal orientation 7 is illustrated in broken lines 12a. With further reference to FIG. 2, when the blade 1 is in its horizontal orientation the strut is at least generally aligned with a straight line 15 extending from the pivot point 11 to the upper mount 13. In this position the strut 12a is fully compressed and is not expressing any, or any significant, swing force on the blade 12a. When. the blade moves towards its vertical orientation the first 10 or 20 degrees of swing faces only minimal gravitational resistance and so the strut need not exert more than minimal swing force through that phase, but a greater force is of course needed when the blade is at 45 degrees (half way through its swing) because at that time the gravitational pressures against the upward swing are at or near their greatest. The strut continues exerting force until the blade arrives at its vertical orientation. The swinging of the blade may be powered by a 12 to 24 volt motor, by an AC motor, or any suitable means.

While some preferred forms of the key elements of the invention have been described by way of example it should be appreciated that modifications and improvements can occur without departing from the scope of the following claims.

1. A circular saw blade having a central attachment portion suitable for functionally attaching the blade to a driving mechanism, a series of saw teeth at the periphery of the blade, a series of apertures between the teeth and the attachment portion arranged to substantially reduce the weight and/or surface area of the blade exposed outside of the central attachment portion.

2. Preferably at least some of the series of apertures extend around the periphery of the blade immediately adjacent the teeth.

3. Optionally the apertures are substantially circular.

4. Optionally the apertures are substantially oblong.

5. Preferably the apertures are arranged such that they serve to capture and hold sawdust during cutting a wooden object such that the held sawdust is expelled from the blade when the apertures which have caught that sawdust are outside the object on their way back into the object.

6. Preferably the apertures account for approximately 5% to 35% of the surface area of the blade exposed outside of the central attachment portion.

7. Preferably the apertures account for approximately 5% to 30% of the surface area of the blade exposed outside of the central attachment portion.

8. Preferably the apertures account for approximately 8% to 25% of the surface area of the blade exposed outside of the central attachment portion.

9. Preferably the apertures account for approximately 10% to 20% of the surface area of the blade exposed outside of the central attachment portion.

10. Preferably apertures nearer the periphery of the blade are larger than apertures nearer the attachment portion.

11. Preferably the apertures are arranged in concentric bands.

12. According to a further aspect of the invention there is provided a sawmill having a circular saw blade, a shaft proceeding between the blade and a first mount, the shaft being able to swing about a pivot point to move the blade between horizontal and vertical orientations when desired, an extendable arm attached at one of its ends to the first mount and at the other of its ends to a second mount, the extendable arm formed such that as the blade moves from the horizontal orientation to the vertical orientation the extendable arm exerts a positive moving force to at least assist movement of the blade, the extendable arm also formed such that as the blade moves from the vertical orientation to the horizontal orientation the extendable arm works against movement of the blade.

13. Preferably when the blade is in one of the horizontal or vertical dispositions the arm is generally aligned with a straight line passing through the pivot point and the point that the arm attaches to the second mount.

14. Preferably when the blade is in the vertical orientation the extendable arm is at least approximately at full extension and does not exert any significant locking force in respect of the blade.

15. Preferably the extendable arm is extendable as a result of gas or liquid pressure

16. Preferably the blade is in the horizontal orientation when the arm is at maximum contraction and in the vertical orientation when the arm is at maximum extension.

17. Preferably the arm exerts no swinging force with respect to the blade when the arm is in a state of maximum contraction or maximum extension.
